(19) United States
(12) Patent Application Publication
(10) Pub. No.: US 2004/0213113 A1
(43) Pub. Date: Oct. 28, 2004

(54) Method for managing copy protection information of recording medium

(76) Inventors: Byung Jin Kim, Sungnam (KR); Hyung Sun Kim, Seoul (KR); Alexandre Stechkine, Seoul (KR)

Correspondence Address: BIRCH STEWART KOLASCH & BIRCH, PO BOX 747, FALLS CHURCH, VA, 22040-0747, US

(21) Appl. No.: 10/831,172

(22) Filed: Apr. 26, 2004

(30) Foreign Application Priority Data
Apr. 24, 2003 (KR) 10-2003-0026150

(51) Int. Cl. G11B 7/004

(52) U.S. Cl. 369/53.21; 369/47.19; 369/30.3

(57) ABSTRACT

A method for managing copy protection information of a recording medium is disclosed. A data stream encrypted using copy protection information is recorded in a data area of an optical disc such as a write once optical disc or a rewritable optical disc, while the copy protection information and a drive ID are recorded together in a key locker of the optical disc. When a data stream of an optical disc is reproduced, reading and decryption of the copy protection information is selectively performed depending on whether the drive ID recorded in the key locker and a drive ID managed in an optical disc drive, into which the optical disc is inserted, are identical. This prevents contents such as broadcast programs recorded in an optical disc from being illegally duplicated.

### BACKGROUND OF THE INVENTION

1. Field of the Invention

The present invention relates to a method for managing copy protection information of a recording medium, and more particularly to a method for improving the security of copy protection information for decrypting A/V data encrypted and recorded in a data area of an optical disc such as a write once optical disc or a rewritable optical disc.

2. Description of the Related Art

Generally, an optical disc, for example a CD or a DVD, capable of recording digital video or audio data has been widely used and commercialized, and as the standardization of a high-density optical disc such as a BD has progressed rapidly, related products are expected to be commercialized in the near future.

To prevent illegal and unauthorized duplication of contents of digital video or audio data recorded in such an optical disc, a copy protection information management method has been proposed in which A/V data encrypted using copy protection information is recorded in a data area of an optical disc and the copy protection information is recorded and managed in a specific area, such as a lead-in area, of the optical disc. This method is described in detail as follows.

FIG. 1 is a block diagram showing the configuration of an optical disc drive 200 and an application 300 to which a general method for managing copy protection information of DVDs is applied. As shown in FIG. 1, the optical disc drive 200 may include an authentication block 20, a key sharing block 21, and encryption blocks 22 and 23.

The application 300 such as a personal computer (PC) may include an authentication block 30, a key sharing block 31, decryption blocks 32 and 33, a descrambler block 34, a decompression block 38, a description disc key 36, and a description title key 37.

An authentication control key, a secured disc key, an encrypted title key, and scrambled A/V data may be stored in a DVD 100 to be inserted into the optical disc drive 200.

The authentication block 20 of the optical disc drive 200 uses an authentication control key read from the DVD 100 to perform a series of authentication processes for transmission and reception of data to and from the authentication block 30 of the application 300. Using a predetermined encryption key provided from the key sharing block 21, the encryption blocks 22 and 23 re-encrypt a secured disc key and an encrypted title key read from the DVD 100 into data suitable for transmission and reception, and then transmit the re-encrypted data.

Using a predetermined description key provided from the key sharing block 31, the decryption blocks 32 and 33 of the application 300 perform a series of operations to decrypt a secured disc key and an encrypted title key received from the optical disc drive 200.

The disc key is decrypted using a master key 35 managed in the application 300, and the title key is decrypted using the decrypted disc key. The descrambler block 34 uses the title key to descramble scrambled A/V data read from the DVD 100. The decompression block 38 decompresses the descrambled A/V data to output original A/V data. Such processes make it possible to prevent unauthorized and illegal duplication of contents of audio or video data scrambled and recorded in the DVD 100.

However, the copy protection information such as the secured disc key and the encrypted title key recorded in the DVD may be illegally hacked and distributed by a third party such as a hacker, allowing illegal duplication of the A/V data encrypted and recorded in the data area of the DVD. It is thus urgently needed to provide an effective solution that can sufficiently reinforce the security of the copy protection information, and particularly to provide an effective solution that can prevent illegal duplication of contents such as digital broadcasts.

### SUMMARY OF THE INVENTION

Therefore, the present invention has been made in view of the above problems, and it is an object of the present invention to provide a method and apparatus for managing copy protection information of a recording medium, which significantly reinforces the security of copy protection information.

It is another object of the present invention to provide a method and apparatus for managing copy protection information of a recording medium, which can effectively prevent illegal duplication of contents such as digital broadcast programs.

It is yet another object of the present invention to provide a method and apparatus for managing copy protection information of a recording medium, which prevents an optical disc, on which digital contents have been recorded by one optical disc drive, from being played by another optical disc drive.

In accordance with the present invention, the above and other objects can be accomplished by the provision of a method for managing copy protection information of a recording medium, the method comprising: encrypting a data stream based on copy protection information and recording the data stream in a data area of a recording medium; and recording a drive ID managed in a drive, which records the data stream, in a first specific area of the recording medium, wherein said copy protection information is previously recorded in the first specific area, and a hidden code for decrypting the copy protection information is previously recorded in a second specific area of the recording medium.

In accordance with another aspect of the present invention, there is provided a method for managing copy protection information of a recording medium, the method comprising the steps of: a) comparing a drive ID read from a first specific area of a recording medium with a drive ID managed in a drive for reproducing the recording medium; b) decrypting copy protection information recorded in the first specific area using a key read from a second specific area of the recording medium if the comparison result at said step a) is that the two drive IDs are identical; and c) decrypting a data stream, encrypted and recorded in a data area of the recording medium, using the decrypted copy protection information.

In accordance with a further aspect of the present invention, there is provided a recording medium, comprising: a data area in which a data stream encrypted using copy protection information is recorded; a first specific area in which the copy protection information and a unique ID of a drive for recording the data stream in the recording medium are recorded; and a second specific area in which a hidden code for decrypting the copy protection information in the first specific area is recorded.

In accordance with yet another aspect of the present invention, there is provided an apparatus for recording and reproducing data in a recording medium, the apparatus comprising: a pickup unit for recording data in the recording medium or reading data from the recording medium; a copy protection information calculation unit for decrypting copy protection information encrypted and recorded in a first specific area of the recording medium; a data processing unit for decrypting data read from the recording medium or encrypting data to be recorded in the recording medium, using the copy protection information; and a storage unit for storing a unique ID of the apparatus, wherein a hidden code for decrypting the copy protection information is recorded in a second specific area of the recording medium, a data stream encrypted using the copy protection information is recorded in a data area of the recording medium, and a unique ID of an apparatus for recording the data stream in the recording medium is additionally recorded in the first specific area.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of an optical disc drive and an application to which a general method for managing copy protection information of a DVD is applied;

FIGS. 2 and 3 are block diagrams showing the configuration of an optical disc drive to which a method for managing copy protection information of a recording medium according to one embodiment of the present invention is applied; and

FIGS. 4 and 5 are block diagrams showing the configuration of an optical disc drive and an application to which a method for managing copy protection information of a recording medium according to another embodiment of the present invention is applied.

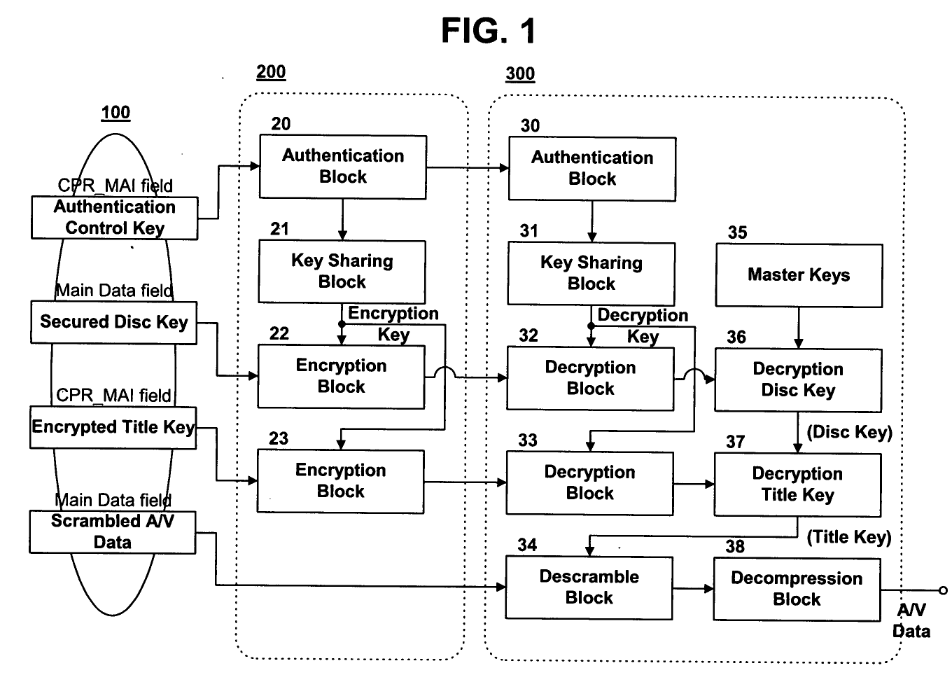

### DETAILED DESCRIPTION OF PREFFERRED EMBODIMENTS

Preferred embodiments of a method for managing copy protection information of a recording medium according to the present invention will now be described in detail with reference to the accompanying drawings.

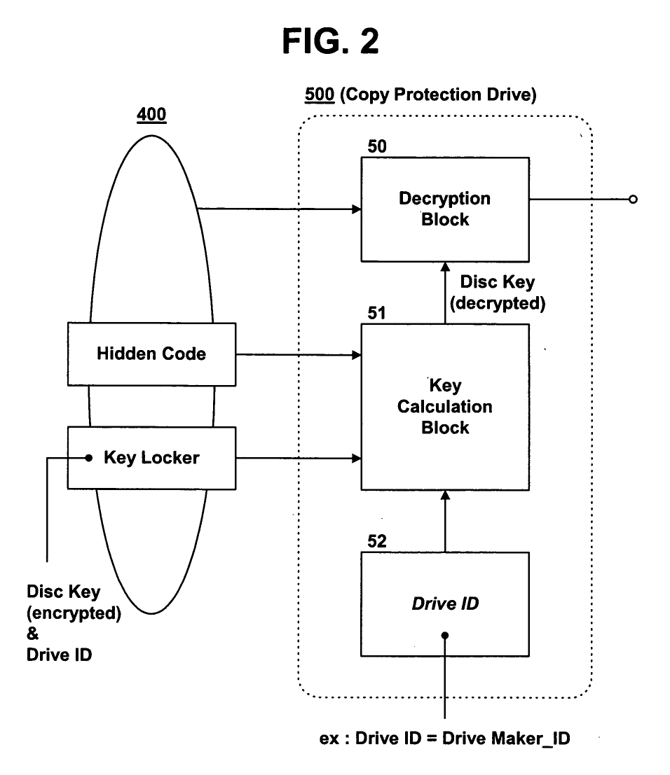

FIG. 2 is a block diagram showing the configuration of an optical disc drive 500 to which the method for managing the copy protection information of the recording medium according to the present invention is applied. As shown in this figure, the optical disc drive 500 may include a decryption block 50 and a key calculation block 51. A unique ID (for example, a drive ID) 52 allocated to the optical disc drive 500 may be managed in the optical disc drive 500.

Copy protection information, for example an encrypted disc key, is recorded in a key locker provided in an optical disc 400 to be inserted into the optical disc drive 500. In addition, a hidden code for reading and decrypting the disc key is prerecorded (as a pre-recorded type) in a specific area of the optical disc 400, for example in a pre-recorded (embossed) area of a lead-in area of the optical disc 400.

To improve the security of the disc key recorded in the key locker, a drive ID is additionally recorded in the key locker. If the drive ID recorded in the key locker is identical to a drive ID managed in the optical disc drive 500, the disc key recorded in the key locker is read and decrypted using the hidden code. On the other hand, if the drive ID recorded in the key locker is not identical to the drive ID managed in the optical disc drive 500, reading and decryption of the disc key is stopped.

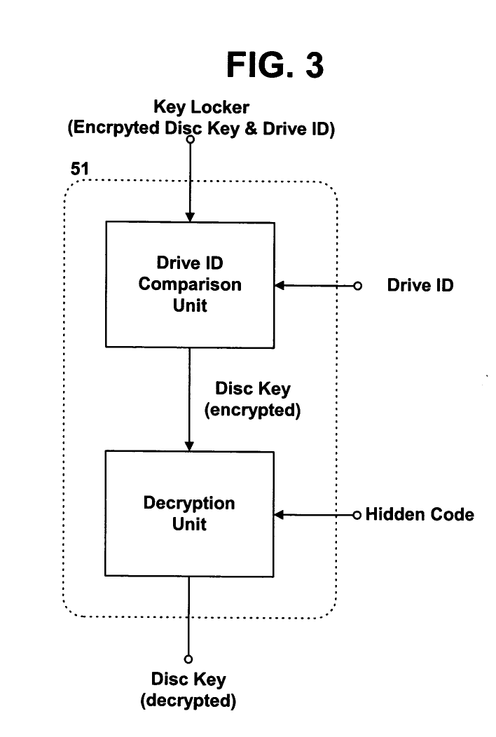

As shown in FIG. 3, the key calculation block 51 of the optical disc drive 500 may include a comparison unit (not referenced) for comparing the drive ID recorded in the key locker with the drive ID managed in the optical disc drive 500, and a decryption unit (not referenced) for selectively reading and decrypting the disc key recorded in the key locker according to the comparison result.

The drive ID can be managed with a different value depending on optical disc drives. For example, unique drive IDs (Drive_ID), which differ from each other, may be managed respectively in drives that are manufactured by each maker.

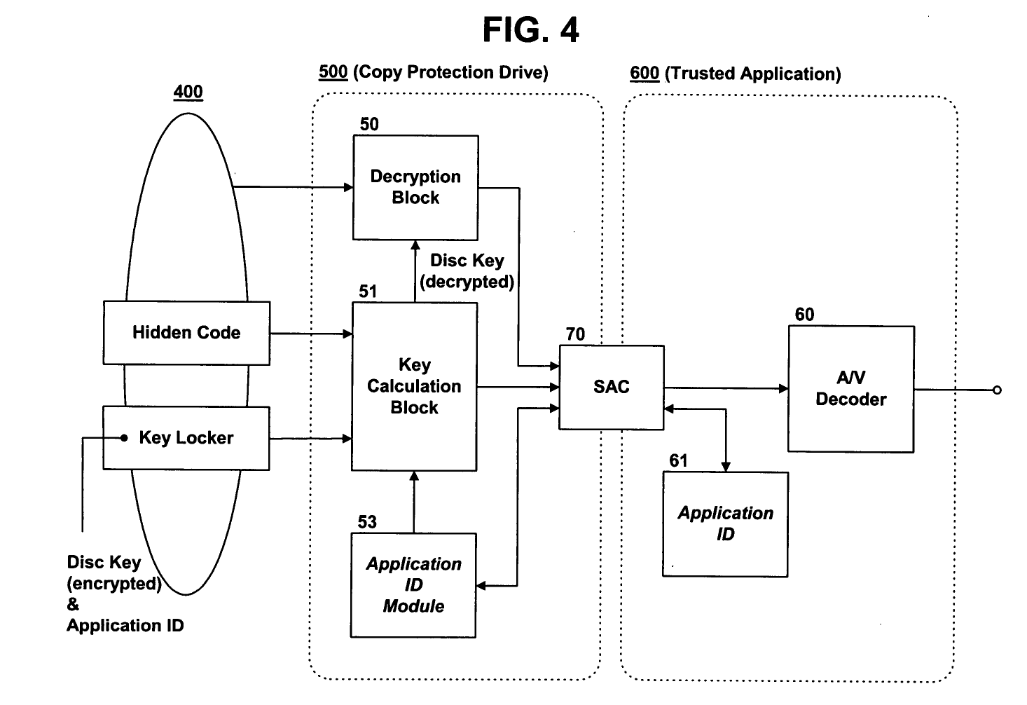

As shown in FIG. 4, the optical disc drive 500 can be used in connection with an application 600 (for example, a personal computer) to and from which the optical disc drive 500 transmits and receives data through a secure authenticated channel (SAC) 70. The application 600 includes an A/V decoder 60 for decoding A/V data received through the secure authenticated channel 70.

The application 600 may manage an application ID 61 therein, and the optical disc drive 500 may include an application ID module 53 therein. In this case, the application ID module 53 receives the application ID 61 managed in the application 600 through the secure authenticated channel 70, and then provides the received application ID 61 to the key calculation block 51.

The key calculation block 51 in the optical disc drive 500 compares the application ID recorded in the key locker of the optical disc 400 with the application ID managed in the optical disc drive 500 or in the application 600, and reads and decrypts the disc key recorded in the key locker using the hidden code only if the two application IDs are identical.

The decryption block 50 performs a series of operations for decrypting audio and video data, encrypted and recorded in the data area of the optical disc, using the disc key. The decryption block 50 then outputs the decrypted audio and video data to the application 600 through the secure authenticated channel 70.

The A/V decoder 60 included in the application 600 decodes the audio and video data, received from the optical disc drive 500 in such a manner, to recover audio and video signals. In such a manner, the audio and video data recorded in the optical disc is normally reproduced.

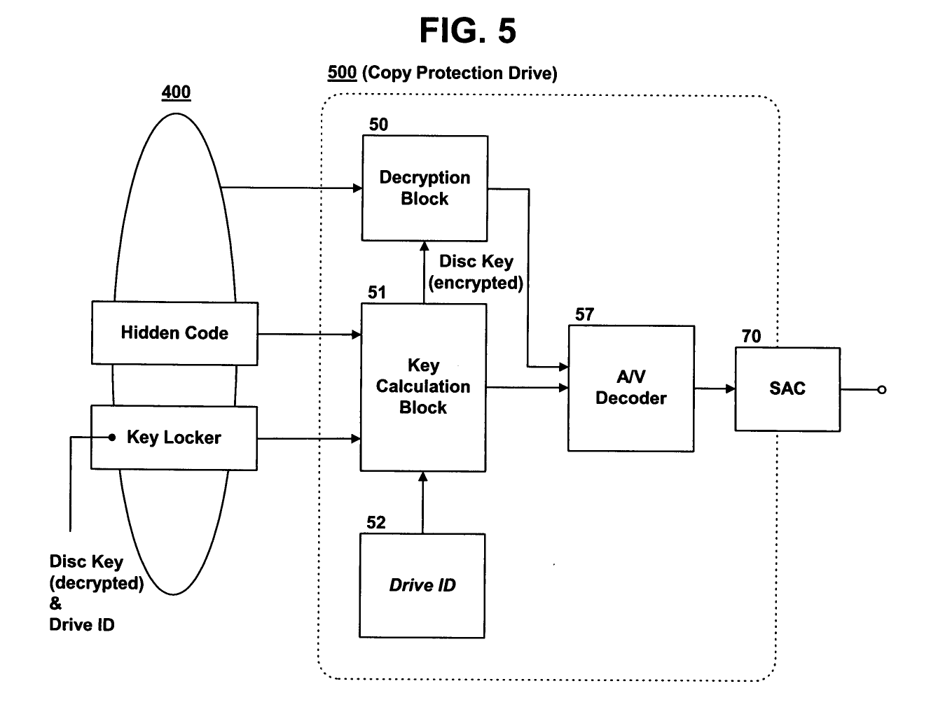

As shown in FIG. 5, an A/V decoder 57 may also be provided not in the application 600 but in the optical disc drive 500. In this case, since the optical disc drive 500 outputs completely decoded audio and video data to the application 600 through the secure authenticated channel 70, the optical disc drive 500 can reduce the risk of hacking of the copy protection information, compared to when bit streams of the audio and video data are transmitted directly to the application 600 as shown in FIG. 4.

In the case of FIG. 5, the optical disc drive 500 does not include the application ID module 53 therein but manages a drive ID 52 therein as shown in FIG. 5.

The optical disc, in which the disc key and the drive ID are recorded together in the key locker thereof and the hidden code is recorded in the specific area thereof as described above, may be a write once optical disc or a rewritable optical disc.

For example, in the case where contents such as digital broadcast programs, which are illegal to duplicate, are recorded in a write once optical disc or a rewritable optical disc, the optical disc drive 500 encrypts a data stream, received through digital broadcasting, using copy protection information, and records the encrypted data stream in a data area of the optical disc. Then, a drive ID managed in the optical disc drive is recorded in a key locker in a specific area of the optical disc where the copy protection information is recorded. A disc key as the copy protection information and a hidden code for reading and decrypting the disc key may be previously recorded in an optical disc when the optical disc is manufactured.

As described above, the copy protection information and the drive ID are recorded together in the key locker in the optical disc, and the hidden code for decrypting the copy protection information is also recorded in the optical disc where the broadcast data stream has been encrypted and recorded in the data recording procedure described above. Through a series of the operations as described above with reference to FIGS. 2 to 5, it is possible to prevent the optical disc from being played if the two drive IDs are not identical as described above.

For reference, the hidden code is recorded on the optical disc in the form of wobble pre-pits (as a wobble pre-pit type) or in the form of a physical wobble having a low frequency component, so that it cannot be illegally duplicated using a bit to bit copy. The drive key, the disc key included in the key locker, or the like can also be recorded in the lead-in area of the optical disc in the form of wobble pre-pits (as a wobble pre-pit type) or in the form of a physical wobble having a low frequency component, as with the hidden key. Here, the drive ID is recorded in the form of pits along a wobble track in a recordable or rewritable area in the key locker. On the other hand, various additional information, in addition to the copy protection information such as a disc key, may be encrypted and recorded in the key locker, which is encrypted by the hidden code and the drive key.

As apparent from the above description, the present invention can significantly improve the security of copy protection information.

The present invention can also prevent decoded digital plain data from being exposed.

Further, the present invention prevents contents such as digital broadcast programs from being illegally duplicated.

Furthermore, the present invention prevents an optical disc, on which digital contents have been recorded by one optical disc drive, from being played by another optical disc drive.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for managing copy protection information of a recording medium, the method comprising:
encrypting a data stream based on copy protection information and recording the data stream in a data area of a recording medium; and
recording a drive ID managed in a drive, which records the data stream, in a first specific area of the recording medium,
wherein said copy protection information is previously recorded in the first specific area, and a hidden code for decrypting the copy protection information is previously recorded in a second specific area of the recording medium.

2. The method according to claim 1, wherein the recording medium is a write once optical disc or a rewritable optical disc.

3. The method according to claim 1, wherein the hidden code is recorded in the form of a wobble having a low frequency component that is not duplicated using a bit to bit copy.

4. The method according to claim 1, wherein the data stream encrypted based on the copy protection information is a digital broadcast data stream that is prohibited from being duplicated.

5. A method for managing copy protection information of a recording medium, the method comprising the steps of:
a) comparing a drive ID read from a first specific area of a recording medium with a drive ID managed in a drive for reproducing the recording medium;
b) decrypting copy protection information recorded in the first specific area using a key read from a second specific area of the recording medium if the comparison result at said step a) is that the two drive IDs are identical; and
c) decrypting a data stream, encrypted and recorded in a data area of the recording medium, using the decrypted copy protection information.

6. The method according to claim 5, wherein if the drive ID managed in the drive and the drive ID read from the recording medium are not identical, the decryption of the copy protection information at said step b) is stopped.

7. The method according to claim 5, wherein the key read from the second specific area is a hidden code recorded in the form of a wobble having a low frequency component that is not duplicated using a bit to bit copy.

8. A recording medium, comprising:
a data area in which a data stream encrypted using copy protection information is recorded;
a first specific area in which the copy protection information and a unique ID of a drive for recording the data stream in the recording medium are recorded; and
a second specific area in which a hidden code for decrypting the copy protection information in the first specific area is recorded.

9. The medium according to claim 8, wherein the recording medium is a write once optical disc or a rewritable optical disc.

10. The medium according to claim 8, wherein the copy protection information and the hidden code are recorded when the recording medium is manufactured.

11. The medium according to claim 8, wherein the hidden code is recorded in the form of a wobble having a low frequency component that is not duplicated using a bit to bit copy.

12. The medium according to claim 8, wherein the data stream recorded in the data area is a digital broadcast data stream that is prohibited from being duplicated.

13. An apparatus for recording and reproducing data in a recording medium, the apparatus comprising:
a pickup unit for recording data in the recording medium or reading data from the recording medium;
a copy protection information calculation unit for decrypting copy protection information encrypted and recorded in a first specific area of the recording medium;
a data processing unit for decrypting data read from the recording medium or encrypting data to be recorded in the recording medium, using the copy protection information; and
a storage unit for storing a unique ID of the apparatus,
wherein a hidden code for decrypting the copy protection information is recorded in a second specific area of the recording medium, a data stream encrypted using the copy protection information is recorded in a data area of the recording medium, and a unique ID of an apparatus for recording the data stream in the recording medium is additionally recorded in the first specific area.

14. The apparatus according to claim 13, wherein the copy protection information calculation unit includes:
a comparison portion for comparing an apparatus ID read from the first specific area with an apparatus ID stored in the storage unit; and
a decryption portion for decrypting the copy protection information read from the first specific area, using the hidden code read from the second specific area, if the two apparatus IDs are identical.

15. The apparatus according to claim 14, wherein if the apparatus ID read from the first specific area and the apparatus ID stored in the storage unit are not identical, the decryption portion stops the decryption of the copy protection information.

16. The apparatus according to claim 13, wherein the data stream recorded in the data area is a digital broadcast data stream that is prohibited from being duplicated.

17. The apparatus according to claim 13, wherein when a digital broadcast data stream prohibited from being duplicated is recorded in the data area, the unique ID stored in the storage unit is additionally recorded in the first specific area of the recording medium.

18. The apparatus according to claim 13, wherein the recording medium is a write once optical disc or a rewritable optical disc.

19. The apparatus according to claim 13, wherein the copy protection information and the hidden code are recorded when the recording medium is manufactured.
